(19) United States
(12) Patent Application Publication
(10) Pub. No.: US 2012/0026091 A1
(43) Pub. Date: Feb. 2, 2012

(54) PEN-TYPE MOUSE

(76) Inventors: Brent Harper, Mazomanie, WI (US); Thomas Mackie, Verona, WI (US)

(21) Appl. No.: 12/848,303

(22) Filed: Aug. 2, 2010

(51) Int. Cl. G06F 3/033; G06F 3/041

(52) U.S. Cl. 345/163; 345/173; 345/179

(57) ABSTRACT

A pen-type mouse includes a shoe that is movable with respect to a flat surface, an elongated body, and a joint connecting the shoe and the body such that the body is at least partially rotatable with respect to the shoe about a first axis that is generally parallel to the flat surface and about a second axis that is also generally parallel to the flat surface, but is prevented from rotating about a third axis that is generally perpendicular to the flat surface. The pen-type mouse can include a position detection module for determining a position of the shoe at each of a plurality of times as the shoe is moved, and a link for communicating the determined positions to a computing device.

### FIELD OF THE INVENTION

The present invention relates to a pen-type mouse for tracking two-dimensional movement with respect to a corresponding flat surface and communicating such movement to a computing device.

### BACKGROUND

In computing, a mouse is a pointing device that functions by detecting movement relative to a supporting surface, with the detected movement communicated to a computing device in order to control the movement of a cursor on a display screen of the computing device. Although there are many different types of mouses, a traditional mouse has a generally low profile, and is held and moved by a user's hand, with the hand typically positioned over the mouse. Such a traditional mouse commonly includes two buttons for performing respective right and left clicks (control commands), and a scroll wheel for indicating a desired amount of movement, such as a desired scrolling or panning amount on a display screen. Other buttons or user inputs can also provide additional control features. Another type of mouse is a pen-type mouse, which has an elongated body that is generally upright like a traditional pen. Such a mouse is advantageous in that it can ameliorate certain repetitive wrist injuries often associated with long-time use of a traditional mouse. However, it would also be advantageous to provide a pen-type mouse which can be comfortably gripped and adjusted to a desired orientation of the user, and which can be used both like a traditional pen and a traditional, mouse.

### SUMMARY

In one aspect, the disclosure relates to an articulating pen-type mouse that has a body and a shoe connected by a joint, wherein the body is movable to a desired orientation with respect to the shoe so that a user can hold the mouse like a traditional pen and move it with respect to an adjacent flat surface while the shoe remains in contact with the flat surface. For example, the pen-type mouse can include an elongated body connected to a shoe via a joint that allows limited rotation between the two components about two different axes but prevents rotation around a third axis generally perpendicular to the other two axes. In this manner, the body can be oriented in a desired orientation that is comfortable for a user while the shoe remains in contact with the flat surface. A relative two-dimensional position value with respect to a reference position can be determined at each of a plurality of time points as the mouse is moved. The tracked movement of the mouse (the position information) can be used to control the position of a cursor on a display screen of a corresponding computing device such as a desktop computer, can be used in a drawing application, or can be for other purposes wherein position information or position information over time is desired. Additionally, the mouse can be used as a traditional pen, that is, it can be moved to form letters and other characters, with determined position information then being input to a character recognition application for translating the movement to specific characters, or to an image capture and verification application.

The mouse can also include one or more user input devices such as optical sensing devices, buttons, and/or touch-detecting surfaces such as touch screens or touch pads, for providing desired user input command signals to the computing device. These input devices can be operable to provide the same functionality that a scrolling wheel, and/or right and left click buttons provide on a traditional mouse, as well as additional functions. Further, the pen-type mouse can also include a detent which allows for the body of the mouse to be held in place with respect to the shoe and allows the mouse to independently remain in an upright position when desired.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying drawings wherein:

FIGS. 1 and 2 are respective front and side views of an exemplary pen-type mouse;

FIG. 3 is a perspective view of the exemplary pen-type mouse of FIGS. 1-2, a traditional pen, and a traditional marker, and shows a size comparison between these items;

FIGS. 4(a)-4(c) are various views of an exemplary nested ball joint of the pen-type mouse of FIGS. 1-3;

FIGS. 5 and 6 are various views of the pen-type mouse of FIGS. 1-3 in partially disassembled states;

FIG. 7 illustrates various components of the exemplary pen-type mouse of FIGS. 1-3;

FIG. 8 is a view of another exemplary nested ball joint for a pen-type mouse;

FIG. 9 is a side view of another exemplary pen-type mouse;

FIG. 10 is a perspective view of the exemplary pen-type mouse of FIG. 9 and illustrates an axis around which the body of the mouse cannot rotate, as well as a touch-detecting surface; and

FIGS. 11(a)-(b) illustrate a detent for holding the body fixed in place with respect the shoe.

### DETAILED DESCRIPTION

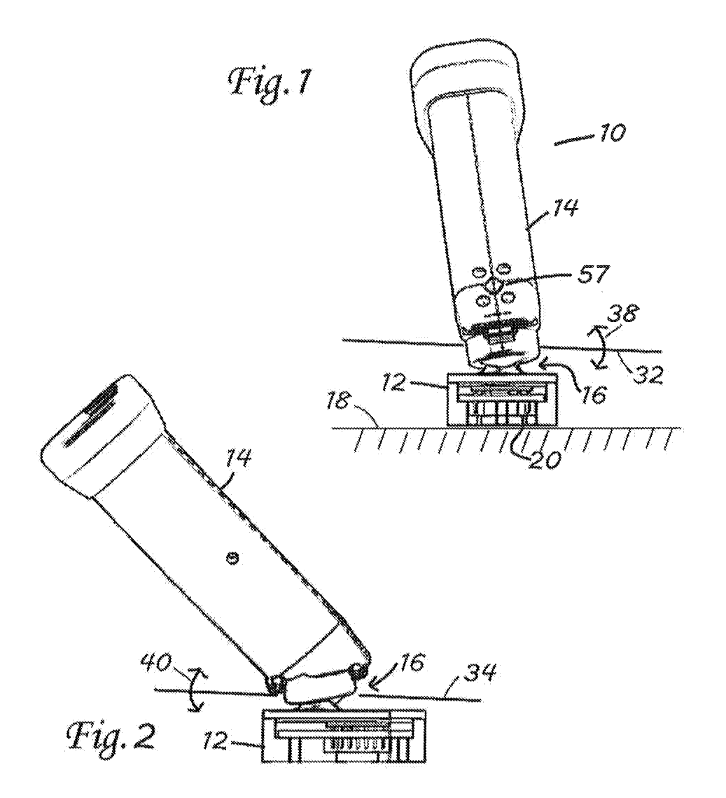

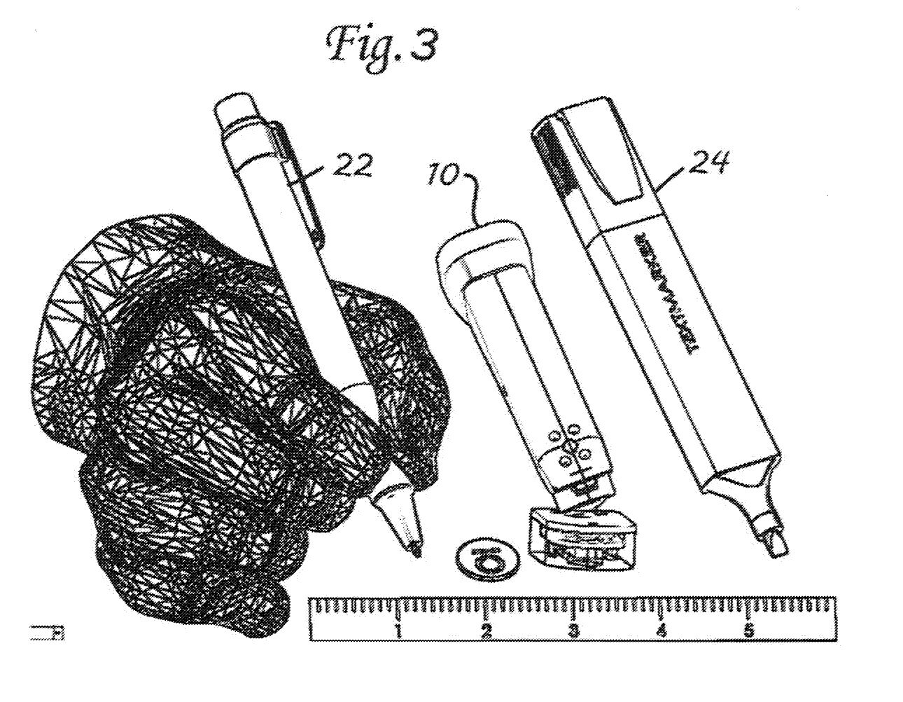

Illustrated in FIGS. 1 and 2 is an exemplary pen-type mouse 10 that includes a shoe 12, an elongated body 14, and a joint 16 for connecting the shoe 12 to the body 14 and allowing for at least partial rotation of the body 14 with respect to the shoe 12 as the shoe 12 rests on or is adjacent to a flat surface. As used herein, the flat surface can be a horizontal, vertical, or angled surface, and can include an electronic display, although as illustrated, the mouse 10 rests on an underlying horizontal surface 18. The shoe 12 is movable by a user on the surface 18 as the body of the pen-type mouse 10 is gripped by a user like a traditional pen, held at a desired orientation, and moved in much the same fashion as a traditional pen or a traditional mouse. Specifically, a bottom surface 20 of the shoe 12 remains in contact with the surface 18 as the mouse is moved. FIG. 3 is an illustration showing a size comparison between a typical pen 22, the exemplary pen-type mouse 10, and a marker 24, and showing that these items are relatively the same size, making the use of the mouse 10 similar to the use of these writing instruments.

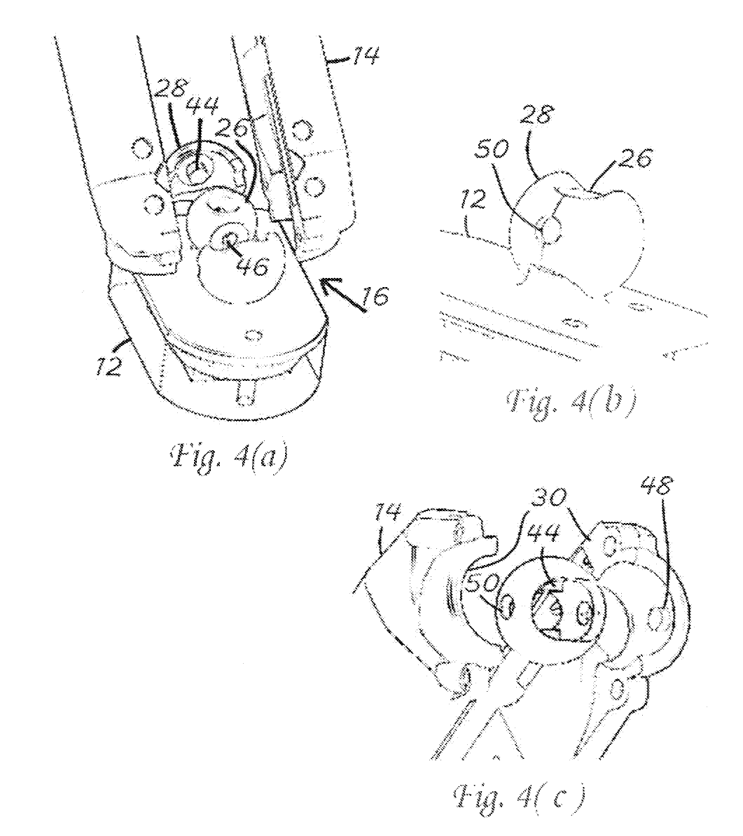

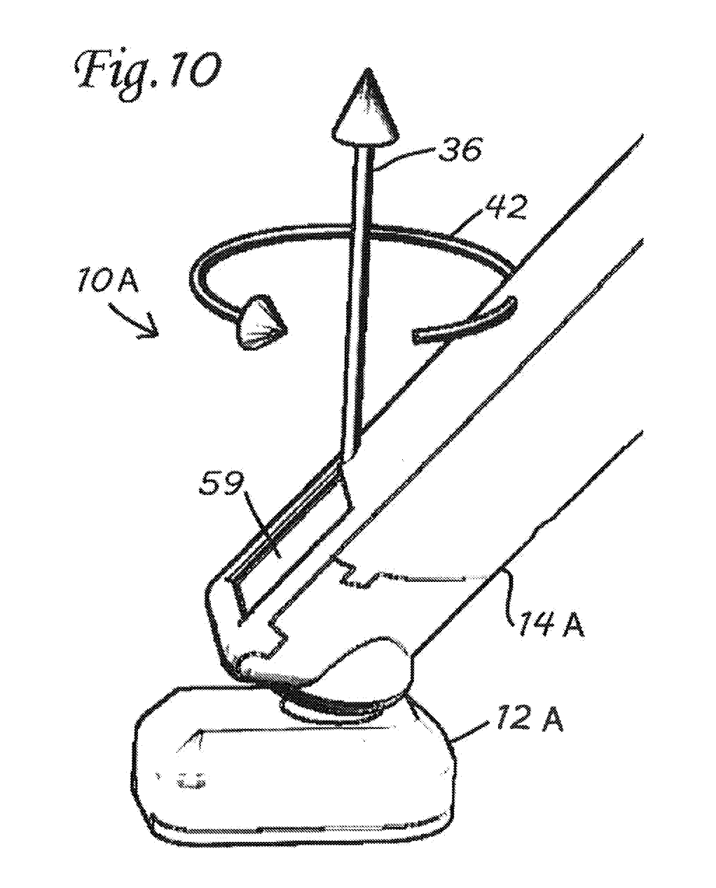

FIGS. 4(a)-4(c) illustrate one embodiment of the joint 16, which can be a nested ball joint. As shown, joint 16 includes a generally rounded inner portion 26 that can be integrally formed with the shoe 12, a generally rounded outer shell portion 28 (which can be formed as two pieces) surrounding the inner portion 26, and a cut-out portion 30 of the body 14 which is complementary in shape to the shape of an outer surface of the outer shell portion 28. The joint 16 allows for at least partial rotation of the body 14 with respect to the shoe 12 around two axes 32, 34 (shown in FIGS. 1 and 2) while preventing rotation around a third axis 36 (shown in FIG. 10). As shown in FIGS. 1 and 2, partial rotation is allowed about axis 32 as indicated by arrow 38 in FIG. 1, and partial rotation is allowed about axis 34 as indicated by arrow 40 in FIG. 2. As shown in FIG. 10, no rotation is allowed around axis 36 in the direction indicated by the arrow 42, which axis is generally perpendicular to the surface over which the mouse moves.

More specifically, referring back to FIGS. 4(a)-(c), inwardly extending pegs 44 [only one shown in FIG. 4(a)] on the inner surface of the outer shell portion 28 are engaged in corresponding holes 46 [only one shown in FIG. 4(a)] in the inner portion 26, such that the outer shell portion 28 is allowed to rotate about axis 34. Similarly, inwardly extending pegs 48 of the cut-out portion 30 are engaged in corresponding holes 50 in the outer shell portion 28, such that the shoe 12 is allowed to rotate about axis 32.

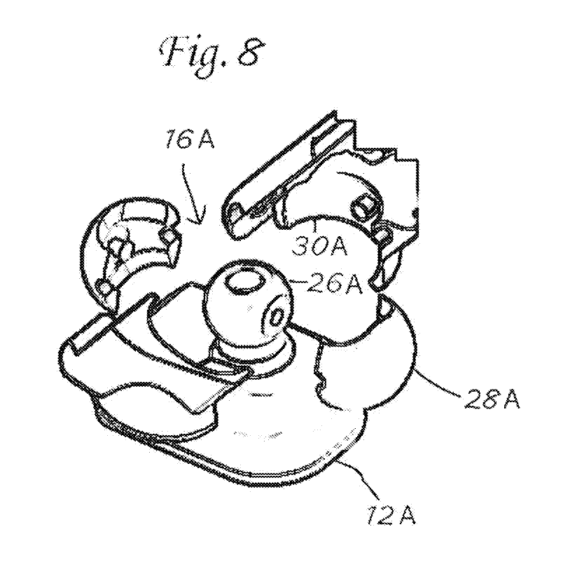

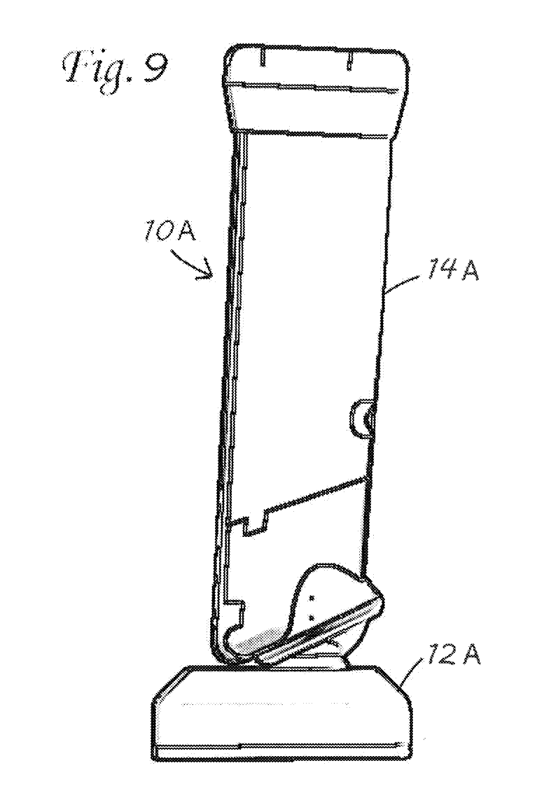

FIGS. 8-10 illustrate another embodiment of a mouse 10A, which includes a shoe 12A, a joint 16A (shown in an exploded view in FIG. 8), and a body 14A. As best seen in FIG. 8, the joint 16A includes an inner portion 26A, an outer shell portion 28A, and a cutout portion 30A of a body 14A. The joint 16A functions essentially the same as joint 16 described above.

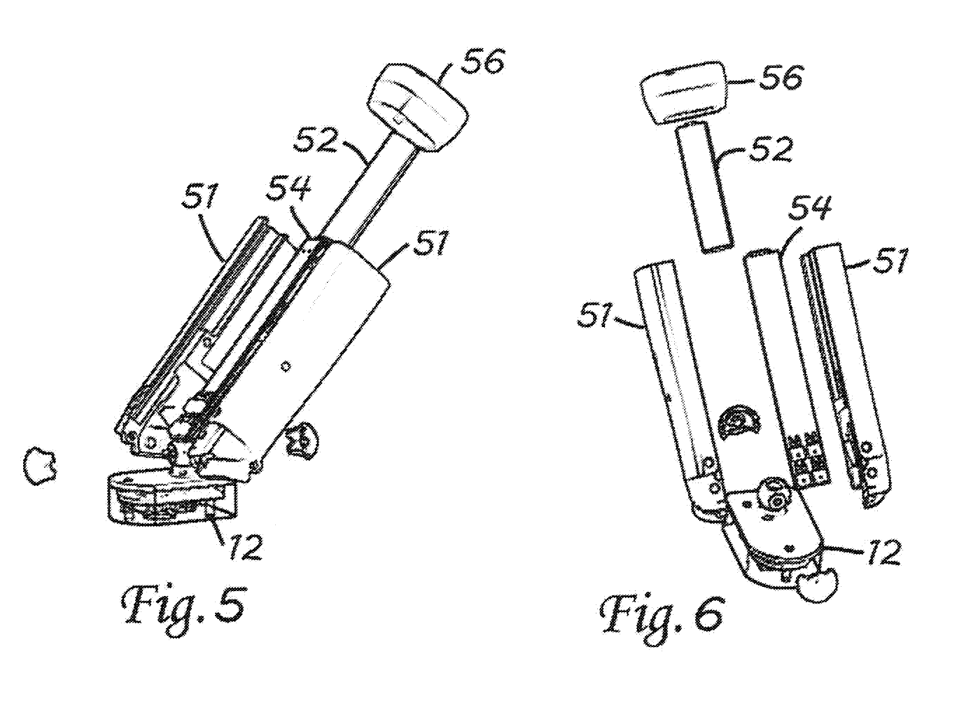

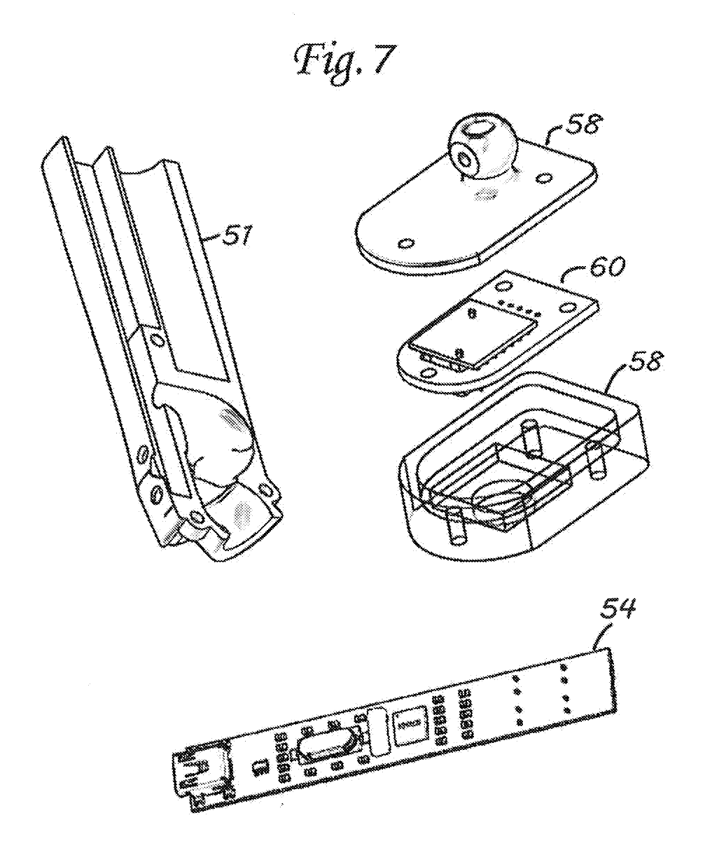

FIGS. 5-7 illustrate in more detail various components of the exemplary mouse 10. For example, the elongated body 14 can be formed in several parts 51 for easy assembly, to form for example a tube-like component with an end cap 56 which allows a battery 52 and a circuit board 54 to fit inside. The mouse is preferably battery powered, although it can also be powered in other ways. Similarly, the shoe 12 can be formed in several parts 58, allowing for a circuit board 60 to fit inside.

For example, the circuit board 58 can include circuitry and applications, including for example a position detection and transmission module for determining a position of the shoe at different times as the mouse is moved, and for transmitting the position information to a computing device in a wired or wireless manner. This module can include sensors, such as optical sensors, accelerometers, or other sensors, for generating sensor outputs indicative of two-dimensional sensed positions of a defined point of the shoe with respect to a reference point, as well as a processor and memory for computing position information from the sensor outputs. The module communicates the position information or merely the sensor outputs to a computing device in a known manner. For example, a wired mouse can use a thin electrical cord terminating in a standard connector, such as a USB, RS-232C, PS/2, ADB or other connector. A wireless mouse can instead transmit data via infrared radiation or radio (including Bluetooth).

The pen-type mouse can include one or more user input devices for providing desired user input commands to the computing device. There are many types of user input devices that would be appropriate, such as optical sensing devices 57 like those shown in FIG. 1, buttons, and/or touch-detecting surfaces (using for example capacitive sensing technology) such as a touch screen or a touch pad 59 like that shown in FIG. 10. Positioning a user input device on the body near the shoe is convenient, in that a user's finger (an index finger for example) can easily access the user input device to indicate a desired command. These input devices can be operable to provide the same functionality as the right click and left click buttons on a traditional mouse, and/or the scrolling wheel of a traditional mouse. Other functionality can also be provided by the circuit board and input devices. For example, in the case that the user input device takes the form of a touch detecting surface, such as a touchpad 59 (or touch screen) like that shown in FIG. 10, designated portions of the touchpad can be assigned such that when touched, a right click or a left click command is initiated. Also, a slide gesture on the touchpad can control a panning motion or zoom motion of an item on a display screen of a corresponding computing device.

The circuit board 54 can thus include circuitry and corresponding applications to interpret user commands from user input devices, and to transmit this information to a computing device such as a computer in a known wired or wireless manner.

The circuit boards and input devices can be operable for example such that, as the mouse is moved, a handwriting detection application operates to translate position information into alphanumeric and other characters (such an application could also be resident on a computing device in communication with the mouse). Also, an application for verifying signatures can be included, which can include such features as scaling text, and implanting signatures into documents.

Other applications can also be included. For example, the position information can be used in conjunction with a drawing application for a drawing displayed on the display screen of a computing device. The mouse can be used like a traditional pen to draw lines on the displayed drawing, and properties or settings of the lines can be changed via user input devices, for example, to change the width, gray level, color range, contrast, and continuity (dashed, dot, continuous) of the lines. As another example, the user input controls can be used in conjunction with the movement of the shoe over the flat surface, such that a three dimensional position of a virtual cursor is controlled in real time.

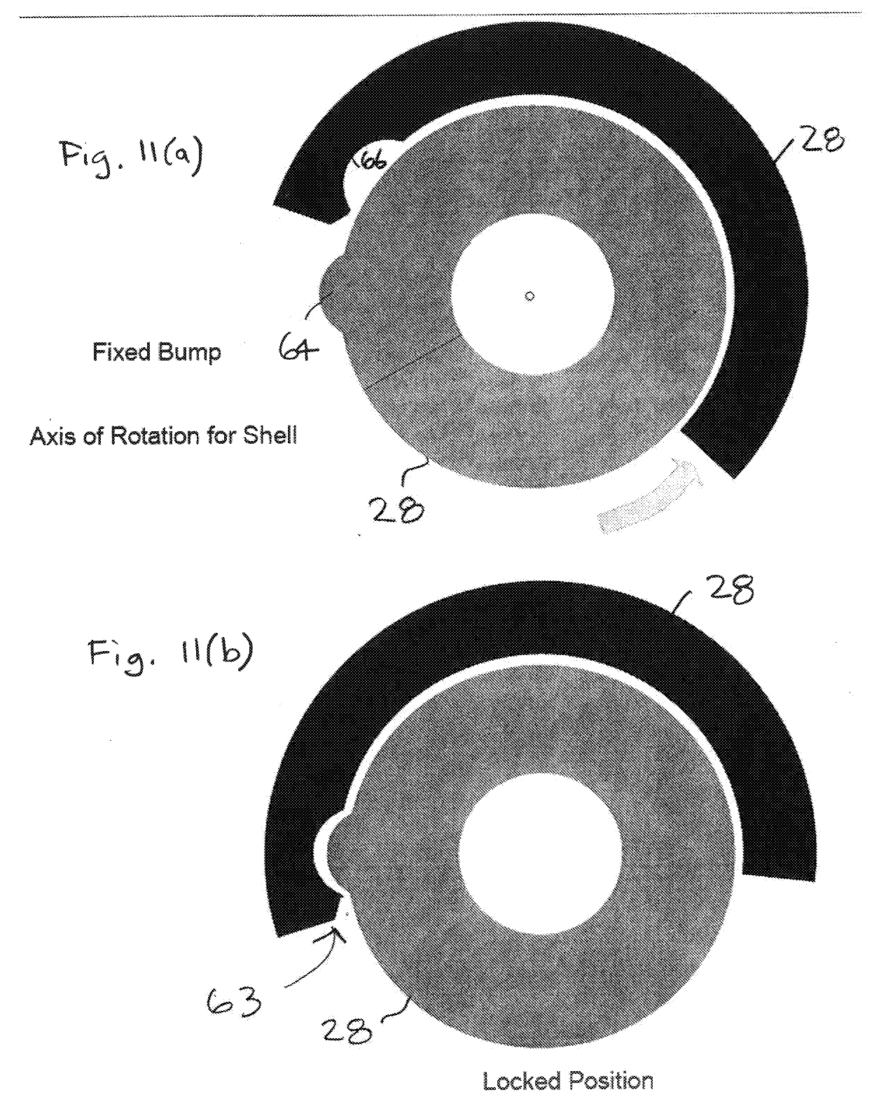

FIGS. 11(a)-(b) illustrate a portion of a body 14 of a mouse, and show a detent 63 for holding the body 14 fixed in place with respect the shoe of the mouse 10. In particular, the outer shell portion 28 can also include a bump 64, and the body 14 can include a complementary shaped indent 66. As the body 14 is rotated about axis 32 (see FIG. 1) to a predetermined extent (such as in a substantially upright position), the bump 64 and the indent 66 are aligned with one another, thus preventing movement of the body 14 with respect to the shoe 12 when a user's hand is removed, and allowing the mouse to remain independently in a substantially upright position. The orientation of the body 14 with respect to the shoe can be changed by a user moving the body about the axis 32, and removing the bump 64 from the indent 66. Other detent mechanisms are also possible.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. A pen-type mouse comprising:
a shoe that is movable with respect to an adjacent flat surface;
an elongated body;
a joint connecting the shoe and the body such that the body is at least partially rotatable with respect to the shoe about a first axis that is generally parallel to the flat surface and about a second axis that is also generally parallel to the flat surface;
a position detection module for determining a position of the shoe at each of a plurality of times as the shoe is moved;
a link for communicating the determined positions to a computing device; and
one or more user input devices for receiving user input and providing one or more control signals to the computing device.

2. The mouse of claim 1, wherein the second axis is generally perpendicular to the first axis

3. The mouse of claim 1, wherein the joint comprises a nested ball joint.

4. The mouse of claim 1, wherein the joint includes an inner portion, an outer shell portion surrounding the inner portion, and a cut-out portion of the body which is complementary in shape to an outer shape of the outer shell portion.

5. The mouse of claim 4, wherein the inner portion and the outer shell portion are generally spherical.

6. The mouse of claim 4, wherein the outer shell portion is constrained to rotate about the first axis with respect to the inner portion, and the body is constrained to rotate about the second axis with respect to the outer shell portion.

7. The mouse of claim 4, wherein the inner portion includes one of a hole and a peg, and the outer shell portion includes a complementary one of a peg and a hole such that the outer shell portion is constrained to rotate about the first axis with respect to the inner portion.

8. The mouse of claim 4, wherein the outer shell portion includes one of a hole and a peg, and the cut-out portion of the body includes a complementary one of a peg and a hole such that the body is constrained to rotate about the second axis with respect to the outer shell portion.

9. The mouse of claim 1, wherein the body is prevented from rotating about a third axis that is generally perpendicular to the flat surface.

10. The mouse of claim 1, wherein the one or more user input devices is responsive to input provided by a finger of a user.

11. The mouse of claim 1, wherein the control signals function as a right click control signal and a left click control signal.

12. The mouse of claim 1, wherein the one or more user input devices include a touch detecting surface.

13. The mouse of claim 12, wherein the touch detecting surface is operable to detect a slide gesture to control panning of an item on a display screen of a computing device.

14. The mouse of claim 1, wherein the one or more user input devices include a plurality of buttons.

15. The mouse of claim 14, wherein the plurality of buttons are operable to control panning of an item on a display screen of a computing device.

16. The mouse of claim 1, wherein the mouse is in electronic communication with a computing device via one of a wired link and a wireless link.

17. The mouse of claim 1, further including a detent for holding the body in an upright position with respect to the shoe.
